(19) United States
(12) Patent Application Publication
(10) Pub. No.: US 2021/0236937 A1
(43) Pub. Date: Aug. 5, 2021

(54) SYSTEM FOR OPTICALLY SCANNING AND DETERMINING A VEHICLE TO CORRESPOND TO A VEHICLE AVAILABLE IN AN ONLINE GAMING PLATFORM

(71) Applicants: Shane Camus, Davie, FL (US); Pablo Camus, Davie, FL (US)

(72) Inventors: Shane Camus, Davie, FL (US); Pablo Camus, Davie, FL (US)

(21) Appl. No.: 16/779,023

(22) Filed: Jan. 31, 2020

(51) Int. Cl. A63F 13/655; G06K 9/22; A63F 13/63; A63F 13/87; A63F 13/803

(52) U.S. Cl. CPC A63F 13/655; G06K 9/228; A63F 13/63; A63F 13/792; A63F 13/803; G06K 2209/23; A63F 13/87

(57) ABSTRACT

A system for determining a vehicle and associating the vehicle with a gaming platform comprising a computing device having a camera to capture image data of a vehicle. An optical recognition module is configured to receive the image data of the vehicle, determine a plurality of vehicle specifications, and associate the plurality of vehicle specifications with a virtual vehicle on a gaming platform provided by a gaming module. The system permits a plurality of users to compete via racing the virtual vehicles.

### TECHNICAL FIELD

The embodiments generally relate to mobile gaming systems and, more specifically, relate to optically scanning objects and engaging with the scanned object in a mobile gaming system.

### BACKGROUND

Modern mobile devices incorporate a variety of technologies to provide the user with a vast array of capabilities. For example, many smartphones include a camera feature, which allows the user to capture digital images of their environment.

Smartphones can also be used as a network-connected gaming console. In recent years, many mobile applications and gaming applications have tried to encourage the physical activity of their users. Moreover, some gaming applications integrate a GPS and the camera feature of the smartphone, providing a more difficult and interactive gaming experience than is seen in traditional gaming consoles. Users can now move about an environment and engage with multiple smartphone technologies while competing with other users in the network.

One example of the above is seen in the PokémonGo game provided on mobile devices in which users move through their environment to participate in the game. The users visualize the environment through the camera on the smartphone to interact with gaming artifacts in an augmented reality platform.

Smartphone cameras can also be used to capture an image and transfer the image, using specialized software, to an object recognition module to determine an identity of the object. In the current arts, no such system exists wherein a system is configured to promote communication and competition between users in the network.

### SUMMARY OF THE INVENTION

This summary is provided to introduce a variety of concepts in a simplified form that is further disclosed in the detailed description of the invention. This summary is not intended to identify key or essential inventive concepts of the claimed subject matter, nor is it intended for determining the scope of the claimed subject matter.

The embodiments presented herein provide a system for determining a vehicle and associating the vehicle with a gaming platform, comprising a computing device having a camera to capture image data of a vehicle. An optical recognition module is configured to receive the image data of the vehicle, determine a plurality of vehicle specifications, and associate the plurality of vehicle specifications with a virtual vehicle on a gaming platform provided by a gaming module. The system permits a plurality of users to compete via racing the virtual vehicles.

The system allows for users to capture image data of vehicles in a real-world environment to acquire and interact with the vehicle in a virtual environment wherein users race against one-another. The system allows users to earn credits or purchase credits in order to purchase or customize vehicles they have acquired. In-game purchasing may allow users to purchase vehicles or upgrades thereof.

In one aspect, the system also includes a vehicle customization module to permit communications between the users via a network. The vehicle specifications include vehicle speed, vehicle acceleration, vehicle handling, and vehicle aesthetics.

In another aspect, the vehicle aesthetics include interior and exterior vehicle aesthetics.

In one aspect, a processor captures image data of a vehicle and associates the vehicle with a virtual vehicle. The vehicle specification then corresponds with the virtual vehicle and the outcome of an interaction between the virtual vehicle of one or more users is determined.

The gaming platform promotes the activity of users by incentivizing users to seek out vehicles in an environment that have favorable vehicle specifications. Users who compete against one another are rewarded for winning the competition.

### BRIEF DESCRIPTION OF THE DRAWINGS

A complete understanding of the present invention and the advantages and features thereof will be more readily understood by reference to the following detailed description when considered in conjunction with the accompanying drawings wherein:

FIG. 1 illustrates a block diagram of the network infrastructure, according to some embodiments;

FIG. 2 illustrates a block diagram of the application system and modules, according to some embodiments;

FIG. 3 illustrates a block diagram of the computing device components associated with the application system, according to some embodiments;

FIG. 4 illustrates a screenshot of the racing interface provided on the display of a computing device, according to some embodiments;

FIG. 5 illustrates a screenshot of the customization interface provided on the display of a computing device, according to some embodiments;

FIG. 6 illustrates a screenshot racing results interface provided on the display of a computing device, according to some embodiments; and

FIG. 7 illustrates a schematic of the image capturing system, according to some embodiments.

### DETAILED DESCRIPTION

The specific details of the single embodiment or variety of embodiments described herein are to the described system and methods of use. Any specific details of the embodiments are used for demonstration purposes only and not unnecessary limitations or inferences are to be understood therefrom.

Before describing in detail exemplary embodiments, it is noted that the embodiments reside primarily in combinations of components and procedures related to the system. Accordingly, the system components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

As used herein, relational terms, such as “first” and “second” and the like, may be used solely to distinguish one entity or element from another entity or element without necessarily requiring or implying any physical or logical relationship or order between such entities or elements.

In general, the embodiments presented herein relate to a mobile application and gaming platform wherein users can engage with one another by racing a virtual vehicle in a virtual environment. To access and utilize vehicles in the gaming platform, the user utilizes a camera in communication with a computing device to capture an image of a vehicle in the environment. The image data is transmitted to an optical recognition engine to determine the make, model, and year of the vehicle. Once the make, model, and year of the vehicle have been determined, the system references a vehicle database to determine the operational specifications and aesthetic characteristics of the vehicle. The operational specifications can include the acceleration, top speed, handling characteristics, and other operational characteristics known in the arts. The aesthetic characteristics of the vehicle can include color options, tire and wheel options, trim options, in addition to customizable options of the vehicles exterior or interior components. Further, the database can include performance options and upgrades as known in the arts.

In some embodiments, the user captures an image of a vehicle in the environment using a camera in communication with a computing device. The user may then access a virtual vehicle corresponding to the captured vehicle while engaging with the gaming platform.

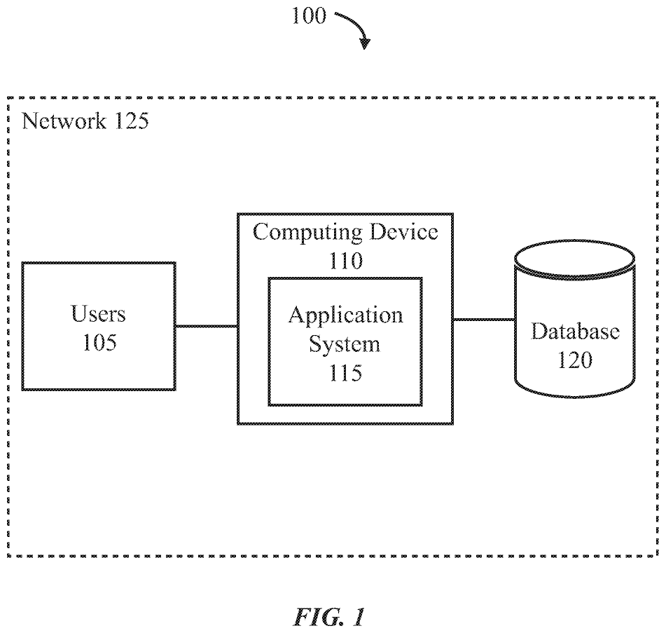

FIG. 1 illustrates the system 100 including a plurality of users 105 who are in operable communication with a computing device 110 having an application system 115 downloaded to local or remote memory. One or more databases 120 are configured to store vehicle and user related data as described hereinabove. Each user 105 is in communication with one another via the network 125. The computing device can include a camera to capture images of an object, such as a vehicle.

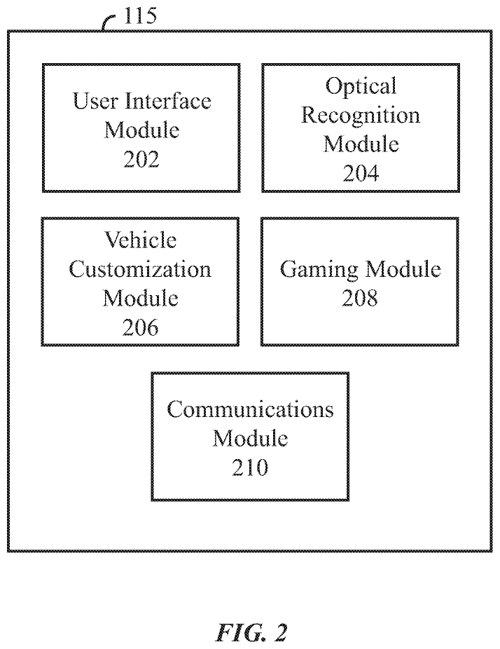

FIG. 2 illustrates the application system 115 having a plurality of modules. The applications system, in general, provides a gaming platform wherein users of the system can capture a vehicle, which corresponds to a virtual vehicle. Users may then compete with the virtual vehicle on the gaming platform. The application system 115 may be comprised of a user interface module 202 providing mobile application functions on the computing device as known in the arts. The optical recognition module 204 receives image data from the camera of the computing device and compares the optical image data to image data stored in the external database to determine the make, model, and year of the vehicle in addition to other vehicle specifications as described hereinabove. A vehicle customization module 206 stores vehicle customization components and allows the user to alter the virtual vehicle to include the customization components, and thus alter the vehicle specifications. The gaming module 208 provides a means for users to compete with one another. In one example, the gaming module 208 allows users to race against one another using virtual vehicles. A communications module 210 permits users to communicate with one another while engaging with the various features of the application system 115.

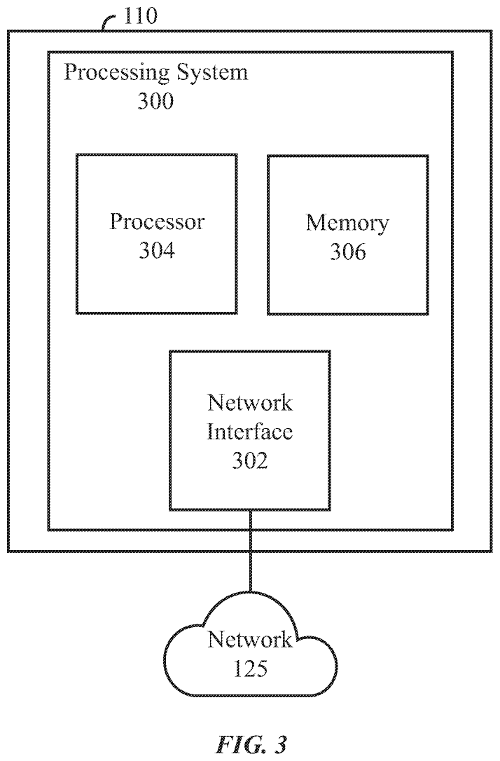

FIG. 3 illustrates a block diagram of the computing device 110 which can include at least one network interface 302 through which the computing device 110 may communicate with external components of the security system either directly or via the network 125. Computing device 110 further includes a processing system 300 programmed or otherwise arranged to implement the system as described hereinabove. Processing system 300 may include one or more processors 304, and a memory module 306. The processing system 300 is coupled to the network interface 302 to enable the processing system 300 to communicate via the network 125 with the devices and computing devices of the gaming platform in addition to various components of the system.

The steps and/or actions of a method or system described in connection with the embodiments disclosed herein may be embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some embodiments, the processor and the storage medium may reside in an Application Specific Integrated Circuit (ASIC). In the alternative, the processor and the storage medium may reside as discrete components in a computing device. Additionally, in some embodiments, the events and/or actions of a method or algorithm may reside as one or any combination or set of codes and/or instructions on a machine-readable medium and/or computer-readable medium, which may be incorporated into a computer program product.

In one or more embodiments, the functions described may be implemented in hardware, software, firmware, or any combination thereof. If implemented in software, the functions may be stored or transmitted as one or more instructions or code on a computer-readable medium. Computer-readable media includes both computer storage media and communication media including any medium that facilitates the transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures, and that can be accessed by a computer. Also, any connection may be termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc,” as used herein, include compact disc (CD), laser disc, optical disc, digital versatile disc (DVD), floppy disk and Blu-ray disc where disks usually reproduce data magnetically, while discs usually reproduce data optically with lasers. Combinations of the above should also be included within the scope of computer-readable media.

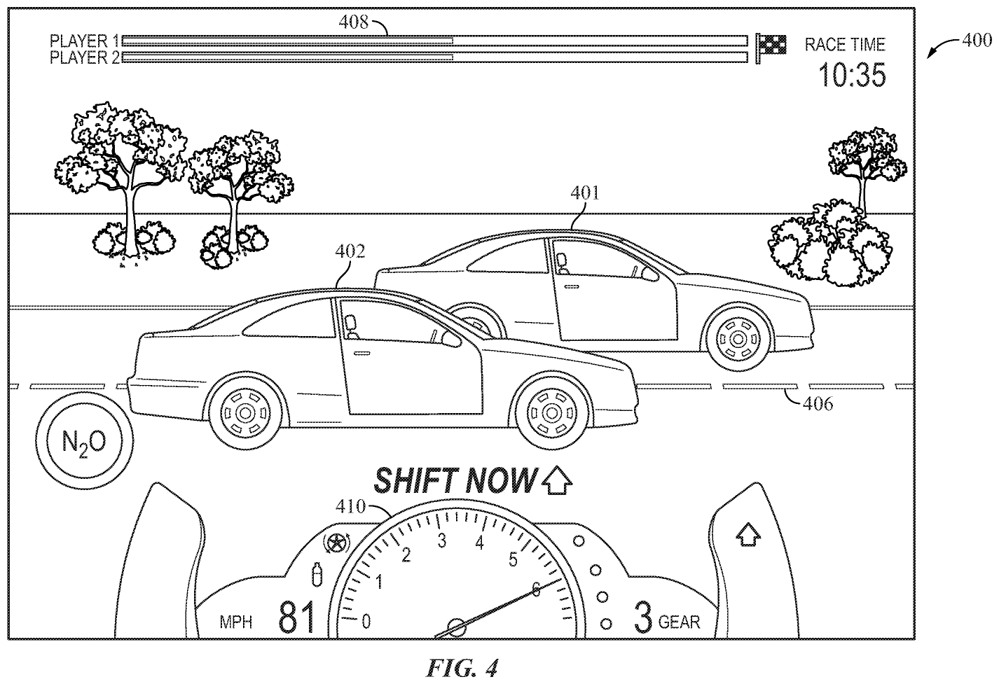

FIG. 4 illustrates a screenshot of the racing interface 400 provided on the display of a computing device. The racing interface 400 illustrates racing content 401 presented within the racing interface 400 in which various racing events occur dependent on user controls. A first vehicle 402 controlled by and corresponding to a first user, and a second vehicle 404 controlled by and corresponded to a second user. In such, each user experiences user-customizable interactive racing content 401 which allows the user to interact with a virtual racing environment 406. A status indicator 408 to indicate the status of each user as determined by their progress, position, speed, or other metric during a race scenario. A control interface 410 provides vehicle control to the user which may include a steering wheel, acceleration and deceleration controls, transmission gear shift controls, and other controls common in virtual vehicle control systems.

In some embodiments, each vehicle (e.g., the first and second vehicle illustrated in FIG. 4) corresponds to a vehicle acquired by a specific user of the system. In such, each vehicle has pre-determined characteristics determined by the user corresponding to the vehicle. For example, although two users may be racing the same vehicle make and model, each user may have customized their corresponding car to have specific characteristics, resulting in differing performance characteristics for the vehicles, and thus resulting in various outcomes of a race depending on the opponent, race conditions, etc.

As used herein, a video game can be an electronic game which involves human interaction with a user interface to generate visual feedback on a computing device within a racing environment. It should be appreciated that the racing environment can be executed within a computing device as described herein. The computing device can include, but is not limited to, a video game console, handheld device, tablet computing device, a mobile phone, and the like. The racing environment can include one or more user interactive elements. Elements can include, but are not limited to, playable characters, non-playable characters, environmental elements, and the like. Further, the racing environment can conform to any genre including, but not limited to, a simulation genre, a strategy genre, a role-playing genre, and the like.

As used herein, the term “environment” is used to describe a physical space surrounding a user of the gaming platform. In some examples, the environment can include a parking lot, roadway, racetrack, or other location where vehicles are present. The term “virtual environment” is used to describe the virtual space in which users interact with one another, such as a virtual raceway.

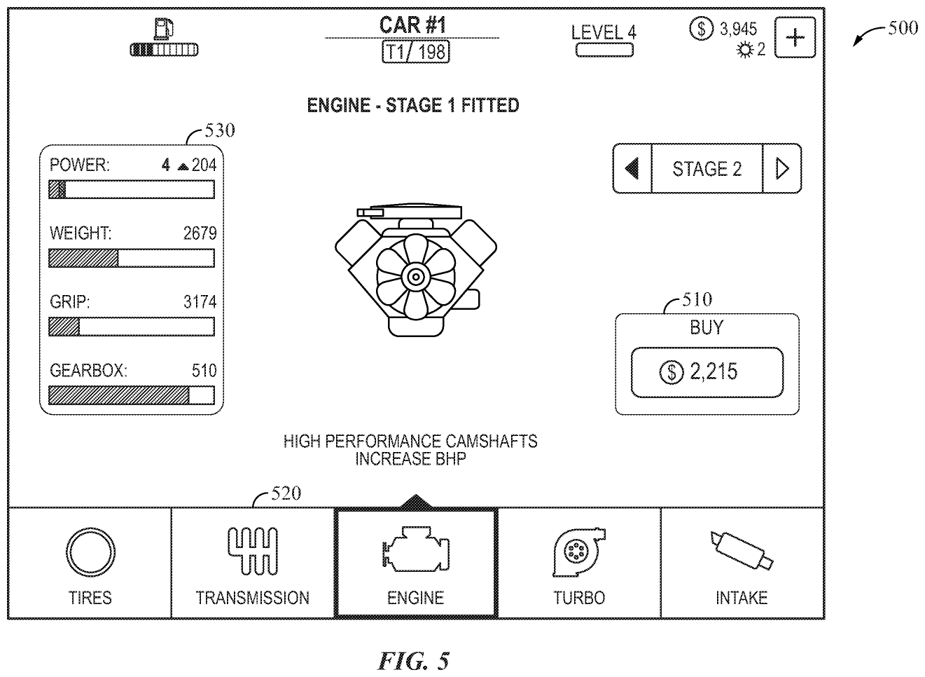

FIG. 5 illustrates a customization interface 500 wherein the user may select from various customizable components and/or features related to a plurality of vehicles corresponding to the user. For example, customizable components 520 may include engine, transmission, exhaust, fabrication, tires, brakes, and the like which may affect the performance of the vehicle. Customizable features may include exterior and/or interior color, wheels, trim, and the like which may affect the aesthetic characteristics of the vehicle. Credits 510 earned during gameplay (i.e., by winning races against opponents or accomplishing in-game tasks) may be utilized to permit the user to purchase vehicle components or aesthetics. In an alternative embodiment, the user may utilize in-game purchasing to purchase credits which can be used to purchase the customizable component or feature.

In some embodiments, the user corresponding to the vehicle may earn points that permit the purchase of components and/or features, which may customize the in-game performance and appearance of the vehicle with which the user utilizes to race an opponent (e.g., another user).

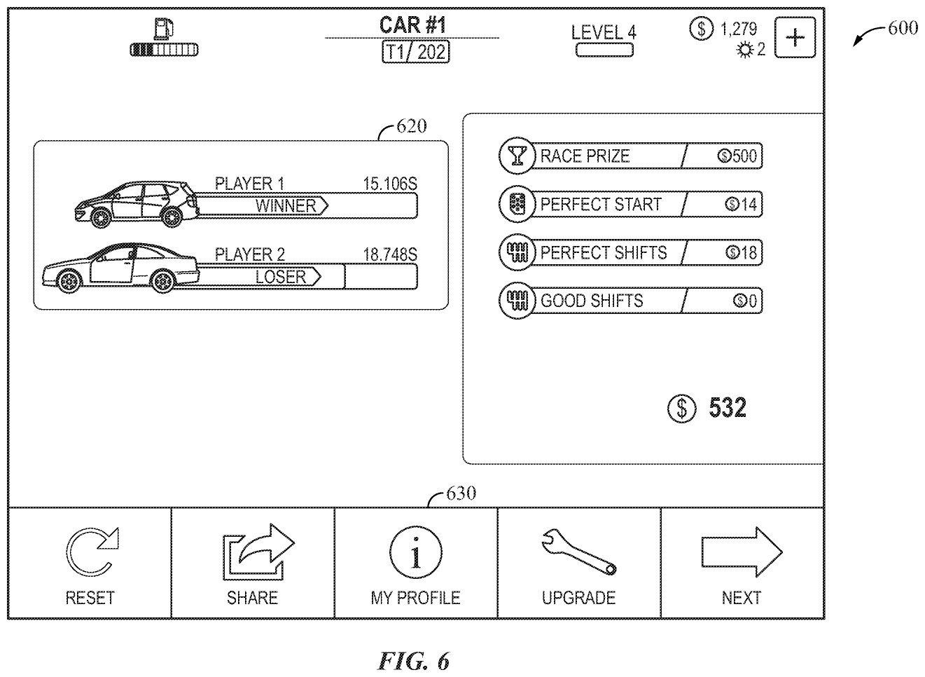

FIG. 6 illustrates a results interface 600 wherein the user may review results of a race with another user. For example, a results portion 620 provides the standings for each user who engaged in the racing scenario. As illustrated, the first user (Player 1) won the race in 15.106 seconds. The results interface may include statistics for the race, including starting statistics, shifting statistics, length of the race, final time taken to complete the race or phases thereof, among other statistics known in the arts. Each statistic may earn the user credits or other accolades. A plurality of selectable tabs 630 may be provided to allow the user to navigate through various interfaces of the system. For example, the selectable tabs 630 may include a “Reset” tab, a “Share” tab, a “My Profile” tab, an “Upgrade” tab, and a “Next” tab. For example, the Share tab may permit the user to share the results of one or more races with other users of the system, social media systems, or contacts. In another example, the Upgrade tab provides the user with the customization interface as shown and described in FIG. 5, or may provide other means for upgrading the vehicle, the users profile, their membership, or likewise customizable features of the system.

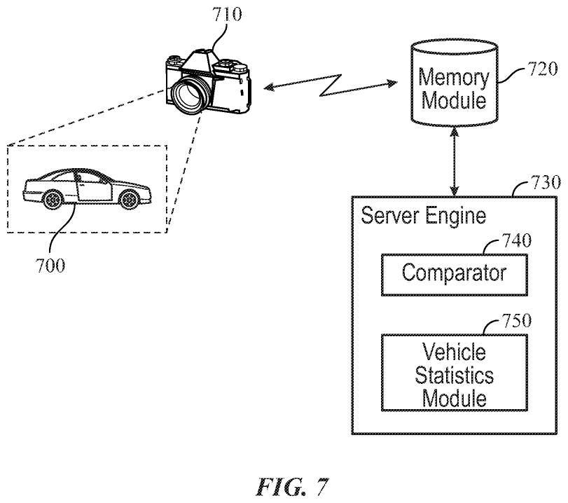

FIG. 7 illustrates a schematic of the vehicle identification system, comprising a vehicle 700 an in environment. A camera 710 is operated by a user to capture image data of the vehicle 700. The image data may include audio, video, or still image data of the vehicle 700. The image data is transmitted to a memory module 720, which stores the image data and which is then transmitted to a server engine 730 that processes the image data to determine one or more of the following: a vehicle make, a vehicle model, a vehicle year, a vehicle color, a tire type, a wheel type, vehicle aftermarket accessories, and other identifying characteristics of the vehicle corresponding to the image data provided by the camera 710. To identify the vehicle 700, a comparator 740 may be utilized to compare the vehicle image data with stored image data for a plurality of vehicles. Once the vehicle 700 is identified, a vehicle statistics module 750 determines statistics for the vehicle which will correspond to performance characteristics of the vehicle.

Through the use real-time or delayed vision object recognition, objects, logos, artwork, products, locations and other features that can be recognized in the image and/or video stream can be matched to data associated with such to assist the user with vehicle recognition and determining information and/or services, which may be beneficial based on such vehicle recognition. In specific embodiments, the data that is matched to the images in the image stream is specific to vehicle performance databases, vehicle aftermarket parts databases, vehicle specification databases and the like.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described hereinabove. A variety of modifications and variations are possible in light of the above teachings without departing from the following claims.

What is claimed is:

1. A system for determining a vehicle and associating the vehicle with a gaming platform, the system comprising:
a computing device including a camera to capture image data of a vehicle;
an optical recognition module configured to receive the image data of the vehicle, determine a plurality of vehicle specifications, and associate the plurality of vehicle specifications with a virtual vehicle on a gaming platform provided by a gaming module permitting a plurality of users to compete via racing the virtual vehicles.

2. The system of claim 1, further comprising a communications module to permit communications between the users via a network.

3. The system of claim 1, further comprising a vehicle customization module configured to provide vehicle customizations to alter the plurality of vehicle specifications.

4. The system of claim 3, wherein the vehicle specifications include vehicle speed, vehicle acceleration, vehicle handling, and vehicle aesthetics.

5. The system of claim 4, wherein the vehicle aesthetics include interior and exterior vehicle aesthetics.

6. A system for determining a vehicle and associating the vehicle with a gaming platform, the system comprising:
a computing device including a camera to capture image data of a vehicle in an environment;
an optical recognition module configured to receive the image data of the vehicle, determine a plurality of vehicle specifications, and associate the plurality of vehicle specifications with a virtual vehicle on a gaming platform provided by a gaming module permitting a plurality of users to compete via racing the virtual vehicles, the user utilizing a computing device including a processor to perform the steps of:
capturing image data of a vehicle;
associating the vehicle with a virtual vehicle;
corresponding the vehicle specification with the virtual vehicle; and
determining the outcome of an interaction between the virtual vehicle of one or more users.

7. The system of claim 6, further comprising a communications module to permit communications between the users via a network.

8. The system of claim 6, further comprising a vehicle customization module configured to provide vehicle customizations to alter the plurality of vehicle specifications.

9. The system of claim 8, wherein the vehicle specifications include vehicle speed, vehicle acceleration, vehicle handling, and vehicle aesthetics.

10. The system of claim 9, wherein the vehicle aesthetics include interior and exterior vehicle aesthetics.

11. A system for determining a vehicle and associating the vehicle with a gaming platform, the system comprising:
a computing device including a camera to capture image data of a vehicle in an environment;
a memory module to store the image data and transmit the image data to an optical recognition module configured to receive the image data of the vehicle, determine a plurality of vehicle specifications, and associate the plurality of vehicle specifications with a virtual vehicle on a gaming platform provided by a gaming module permitting a plurality of users to compete via racing the virtual vehicles, the user utilizing a computing device including a processor to perform the steps of:
capturing image data of a vehicle;
associating the vehicle with a virtual vehicle;
corresponding the vehicle specification with the virtual vehicle; and
determining the outcome of an interaction between the virtual vehicle of one or more users.

12. The system of claim 11, wherein a racing interface provides a first user with a user interface illustrating a first vehicle corresponding to the first user, and a second vehicle corresponding to a second user.

13. The system of claim 12, wherein the racing interface is further comprised of a control interface to provide vehicle controls to the first user.

14. The system of claim 13, wherein the control interface provides control of the first vehicle during a racing scenario.

15. The system of claim 14, further comprising a results interface to display the results of a race.

16. The system of claim 15, wherein credits are earned from the results of the race.

17. The system of claim 11, further comprising a communications module to permit communications between the users via a network.

18. The system of claim 17, wherein the vehicle customization module permits the customization of vehicle components.

19. The system of claim 18, wherein the customization module changes the performance characteristics of the vehicle, wherein the performance characteristics change the vehicle specifications.

20. The system of claim 19, wherein the vehicle specifications include vehicle speed, vehicle acceleration, vehicle handling, and vehicle aesthetics.
